(19) United States
(12) Patent Application Publication
(10) Pub. No.: US 2011/0072515 A1
(43) Pub. Date: Mar. 24, 2011

(54) METHOD AND APPARATUS FOR COLLABORATIVELY PROTECTING AGAINST DISTRIBUTED DENIAL OF SERVICE ATTACK

(75) Inventors: Pyung-Koo PARK, Daejeon (KR); Tae Ho Lee, Daejeon (KR); Soon Seok Lee, Daejeon (KR); Sung Back Hong, Daejeon (KR)

(73) Assignee: Electronics and Telecommunications Research Institute, Daejeon (KR)

(21) Appl. No.: 12/882,557

(22) Filed: Sep. 15, 2010

(30) Foreign Application Priority Data
Sep. 22, 2009 (KR) 10-2009-0089575
Aug. 13, 2010 (KR) 10-2010-0078305

(51) Int. Cl. G06F 11/00; G06F 15/173

(52) U.S. Cl. 726/22; 709/224

(57) ABSTRACT

A method and apparatus for collaboratively protecting against a Distributed Denial of Service (DDoS) attack are provided. The method performed by a network apparatus includes detecting data suspected as being used in the DDoS attack by monitoring traffic forwarded to a service server, notifying a security apparatus that the detected data is suspected as being used in the DDoS attack, and performing at least one of a first operation and a second operation, the first operation being receiving an analysis result for the detected data from the security apparatus and controlling the traffic based on the analysis result, and the second operation being controlling, prior to the first operation, the traffic based on a rule set in advance.

### CROSS-REFERENCE TO RELATED APPLICATION

This application claims the benefit of Korean Patent Application No. 10-2009-0089575 and of Korean Patent Application No. 10-2010-0078305, respectively filed on Sep. 22, 2009 and Aug. 13, 2010, in the Korean Intellectual Property Office, the disclosure of which is incorporated herein by reference.

### BACKGROUND

1. Field of the Invention

The present invention relates to a protection system that may support active and efficient protection against a Distributed Denial of Service (DDoS) attack where multiple distributed attackers simultaneously cause service faults in a single service provider.

2. Description of the Related Art

A Distributed Denial of Service (DDoS) attack is a kind of attack pattern where multiple attackers attack a single service provider and cause service faults. To protect against a DDoS attack, a conventional security apparatus performs all protection operations, for example, analyzing an attack pattern, determining an attack, and controlling attack data with respect to all data. A security apparatus is responsible for security of a service provider. A network apparatus, such as a router, transmits all input data to the security apparatus.

Since the security apparatus performs the protection operations, such as analyzing, determining and controlling with respect to all data, as described above, a load on the security apparatus may be increased. An increase in the load may result in an increase in a failure rate of the protection operations, as well as a decrease in quality of service provided by normal data passing through the security apparatus. As a result, the DDoS attack is considered to be successful.

### SUMMARY

An aspect of the present invention provides a method and apparatus for collaboratively protecting against a Distributed Denial of Service (DDoS) attack that may determine an attack by an external device and May respond to the determined attack in a collaborative protection system including a network apparatus and a security apparatus, thereby minimizing a load of the security apparatus, and implementing a more efficient protection system.

According to an aspect of the present invention, there is provided as method of collaboratively protecting against a DDoS attack, the method being performed by a network apparatus, and including detecting data suspected as being used in the DDoS attack by monitoring traffic forwarded to a service server; notifying a security apparatus that the detected data is suspected as being used in the DDoS attack; and performing at least one of a first operation and a second operation, the first operation being receiving an analysis result for the detected data from the security apparatus and controlling the traffic based on the analysis result, and the second operation being controlling, prior to the first operation, the traffic based on a rule set in advance.

The detecting may include checking for an occurrence pattern of input data based on flow information of the input data, determining whether the occurrence pattern of the input data is identical to an attack pattern registered in the network apparatus, and determining the input data suspected as being used in the DDoS attack when the occurrence pattern of the input data identical to the attack pattern registered in the network apparatus.

The occurrence pattern of the input data may be determined based on at least one of an amount of data input per unit time information on Whether data ha ma a same size repeatedly occurs, and information on whether data for a specific function repeatedly occurs.

The notifying may include flagging the detected data as anomalous data, based on a scheme agreed upon between the network apparatus and the security apparatus, and forwarding the flanged data to the security apparatus.

The notifying may include providing the security apparatus with flow information of the detected data, the flow information including at least one of a source address, a destination address, and a port number, and forwarding the detected data to the security apparatus.

The analysis result may include information regarding an attack pattern of the detected data, and information regarding a protection operation to be performed by the network apparatus.

The information regarding the protection operation may include at least one of a rate limit for the traffic, a complete dropping of the traffic, and a dropping probability for the traffic.

The first operation may include registering an attack pattern contained in the analysis result, when the analysis result indicates an attack pattern of the DDoS attack, and dropping the traffic, of the DDoS attack based on the protection operation for the traffic, the protection operation being contained in the analysis result.

The dropping may include registering the protection operation for the traffic, and transmitting information regarding the protection operation to a network control system so that the traffic of the DDoS attack is dropped by a network ingress apparatus.

According to another aspect of the present invention, there is provided as method of collaboratively protecting against a DDoS attack, the method being performed by as security apparatus and including: receiving data from a network apparatus, the network apparatus monitoring traffic forwarded to a service server; verifying whether the data is suspected as being used in the DDoS attack, based on flow information of the received data or flag information included in the received data, the flow information being provided by the network apparatus; analyzing, the data and determining whether the data is used in the DDoS attack, when the data is suspected as being used in the DDoS attack; and transmitting a analysis result for the data to the network apparatus.

The analysis result may include information regarding an attack pattern of the data, and information regarding a protection operation to be performed by the network apparatus.

According to another aspect of the present invention, there is provided a network apparatus for collaboratively protecting against as DDoS attack, the network apparatus including: a data monitoring unit to detect data suspected as being used in the DDoS attack by monitoring traffic forwarded to a service server; a communication unit to notify a security apparatus that the detected data is suspected as being used in the DDoS attack; and a controller to perform at least one of a first operation and a second operation, the first operation being receiving an analysis result for the detected data from the security apparatus and controlling the traffic based on the analysis result, and the second operation being controlling, prior to the first operation, the traffic based on a rule set in advance.

The data monitoring unit may include a pattern determiner to check for an occurrence pattern of input data based on flow information of the input data, and to determine whether the occurrence pattern of the input data is identical to an attack pattern registered in the network apparatus; and a suspect data determiner to determine the input data suspected as being used in the DDoS attack, when the occurrence pattern of the input data is identical to the attack pattern registered in the network apparatus.

The network apparatus may further include an identification flagging unit to flag the detected data as anomalous data, based on a scheme agreed upon between the network apparatus and the security apparatus. The communication unit may forward the flagged data to the security apparatus.

The communication unit may forward, to the security apparatus, the detected data and flow information of the detected data, the flow information including at least one of a source address, a destination address, and a port number.

When the analysis result indicates an attack patient of the DDoS attack, the controller may perform the first operation by registering an attack pattern contained in the analysis result, and by dropping the traffic of the DDoS attack based on the protection operation for the traffic, the protection operation being contained in the analysis result.

The network apparatus may further include a protection operation registration unit to register the protection operation for the traffic.

The controller may request the network apparatus to transmit information regarding the protection operation to a network control system so that the traffic of the DDoS attack may be dropped by a network ingress apparatus.

According to another aspect of the present invention, there is provided a security apparatus for collaboratively protecting against a DDoS attack, the security apparatus including: a data verification unit to verify whether data is suspected as being used in the DDoS attack, based on flow information of the received data or flag information included in on the data, the flow information being provided by at network apparatus; a determination unit to catalyze the data and determine whether the data is used in the DDoS attack, when the data is suspected as being used in the DDoS attack; and a communication unit to receive data front the network apparatus, and to transmit a analysis result for the data to the network apparatus, the network apparatus monitoring traffic forwarded to a service server.

### EFFECT

According to embodiments of the present invention, a network apparatus may detect anomalous data, and may forward the detected data to a security apparatus. The security apparatus may precisely analyze the anomalous data detected by the network apparatus, and may recognize an attack pattern, thereby reducing a load of the security apparatus. Additionally, the attack pattern detected by the security apparatus may be stored in the network apparatus and thus, the network apparatus may primarily protect against attack data while maintaining original functions.

Moreover, according to embodiments of the present invention, it is possible to actively respond to a Distributed Denial of Service (DDoS) attack through a collaboration between a security apparatus and a network apparatus.

Furthermore, a load of a security apparatus may be reduced by a collaborative protection system, to reduce a failure rate of protection operations. In addition, it is possible to implement an active protection system by quickly responding to an attack.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a network system for collaboratively protecting against a Distributed Denial of Service (DDoS) attack according to an embodiment of the present invention;

FIG. 2 is a block diagram illustrating, the network apparatus of FIG. 1;

FIG. 3 is a diagram illustrating an example of a flagging operation to identify detected data as suspect data;

FIG. 4 is a block diagram illustrating a security apparatus of FIG. 1 for collaboratively protecting against a DDoS attack;

FIG. 5 is a diagram illustrating a part of a network system for collaboratively protecting against a DDoS attack according to another embodiment of the present invention;

FIG. 6 is a flowchart illustrating a scheme of setting a rule for an attack pattern and protection in a network apparatus according to an embodiment of the present invention;

FIGS. 7 and 8 are flowcharts illustrating a method of collaboratively protecting against a DDoS attack in a network apparatus according to an embodiment of the present invention; and

FIG. 9 is a flowchart illustrating a method of collaboratively protecting against a DDoS attack in a security apparatus according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

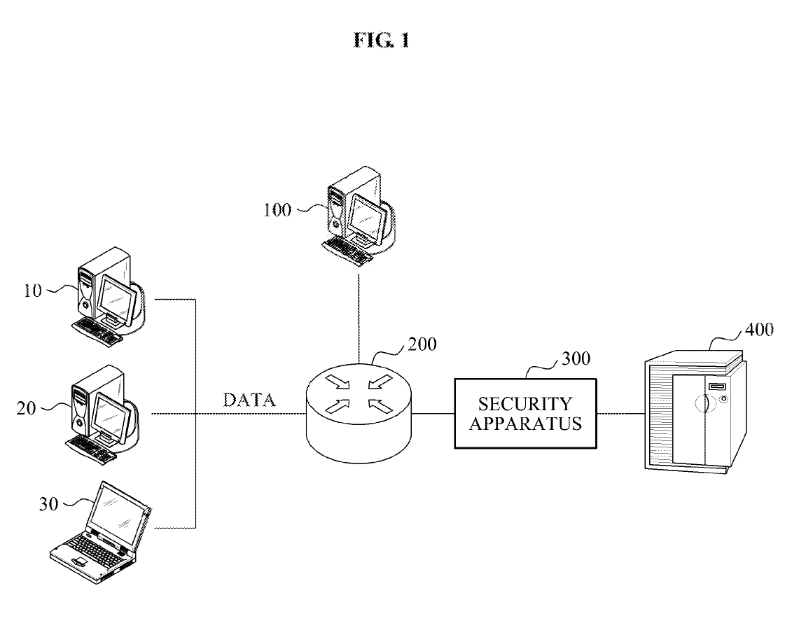

FIG. 1 is a diagram illustrating a network system for collaboratively protecting against a Distributed Denial of Service (DDoS) attack according to an embodiment of the present invention.

Referring to FIG. 1, the network system may include a network control system 100, a network apparatus 200, a security apparatus 300, and a service server 400.

The network control system 100 may function as a server to manage and control the network apparatus 200.

The network apparatus 200 may forward data input from external devices 10, 20, and 30, to the security apparatus 300, and may be implemented, for example, as to router. Additionally, the network apparatus 200 may primarily protect against to DDoS attack, based on a collaboration with the security apparatus 300. The DDoS attack may consist of distributed multiple attackers simultaneously attacking and may cause service faults to occur. The multiple attackers may be generated from at least one of the external devices 10, 20, and 30 of FIG. 1.

The security apparatus 300 may be responsible for security of the service server 400, and may secondarily protect against the DDoS attack based on the collaboration with the network apparatus 200. For example, the security apparatus 300 may precisely analyze data of which flow information is provided by the network apparatus 200, or data having a flagged packet, and may detect an attack pattern. When the data is determined as data for an attack, the security apparatus 300 may request the network apparatus 200 to perform a protection operation. Examples of the security apparatus 300 may include an Intrusion Detection System (IDS), an Intrusion Prevention System (IPS) or a firewall.

The service server 400 may function as a service provider to provide services to multiple users connected via a network.

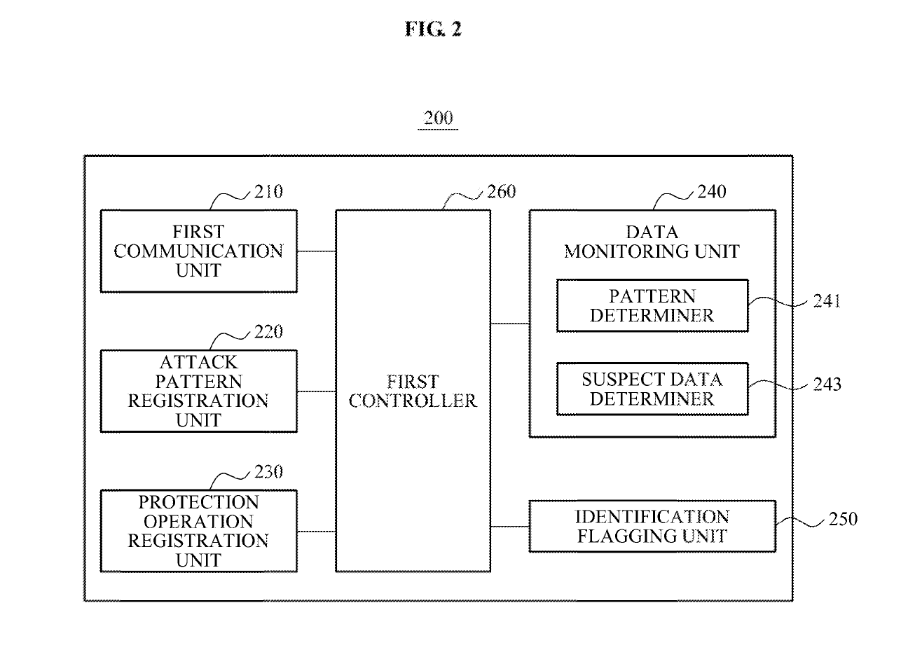

FIG. 2 is a block diagram illustrating the network apparatus 200 of FIG. 1.

Referring to FIG. 2, the network apparatus 200 may include a first communication unit 210, an attack pattern registration writ 220, a protection operation registration unit 230, as is data monitoring unit 240, an identification flagging unit 250, and a first controller 260.

The first communication unit 210 may communicate with the plurality of external devices 10, 20, and 30, the network control system 100, and the security apparatus 300. The first communication unit 210 may perform communication in a wired or wireless manner. The external devices 10, 20, and 30 may be implemented as terminals for receiving a service provided by the service server 400, or as zombie terminals for attacking the service server 400.

For example, the first communication unit 210 may transfer data input from the external devices 10, 20, and 30 to the data monitoring unit 240. Additionally, the first communication unit 210 may notify the security apparatus 300 that data suspected as being used in a DDoS attack is detected by the data monitoring unit 240. The first communication unit 210 may receive an analysis result for the detected suspect data from the security apparatus 300.

The attack pattern registration unit 220 may be registered with an attack pattern set by an operator. For example, the attack pattern may include a volume attack where data having a same size is continuously repeated, and an attack where data that is difficult to be repeatedly generated is repeatedly requested, for example, an Internet Control Message Protocol (WIMP) data and a Hypertext Transfer Protocol (HTTP) GET data. However, this is merely an example of the attack, and there is no limitation there). Additionally, the attack pattern registration unit 220 may be registered with an attack pattern analyzed by the security apparatus 300.

When suspect data, front the external devices 10, 20, and 30 and suspected as being used in an attack, is detected, the protection operation registration unit 230 may set in advance a rule that is used in a second operation that will be described later. The rule set in advance may include at least one of a rate limit for traffic, a complete dropping of traffic, and a dropping probability for traffic. Additionally, the protection operation registration unit 230 may be registered with a protection operation for traffic that is included in the analysis result. The protection operation included in the analysis result may be applied to a first operation that will be described below.

When data suspected as being used in an attack is detected from new traffic, the set rule and the registered protection operation may be used when attack data is protected against using the second operation. Additionally, rules or protection operations may be set or registered for each attack pattern.

The data monitoring unit 240 may detect data suspected as being used in a DDoS attack by monitoring traffic forwarded to the service server 400. To detect, the suspect data, the data monitoring unit 240 may include a pattern determiner 241, and a suspect data determiner 243

The pattern determiner 241 may check for an occurrence pattern of data input from the external devices 10, 20, and 30, based on flow information of the input data, and may determine whether the occurrence pattern of the input data is identical to an attack pattern registered in the attack pattern registration unit 220.

The occurrence pattern of the input data may be determined based on at least one of an amount of data input per unit time, information on whether data having a same size repeatedly occurs, and information on whether data for a specific function repeatedly occurs.

The suspect data determiner 243 may determine the input data as suspect data suspected as being used in a DDoS attack, when the occurrence pattern of the input data is identical to an attack pattern registered in the attack pattern registration unit 220. Accordingly, the suspect data may be detected.

The identification flagging unit 250 may flag the detected data as the suspect data, namely anomalous data, based on a scheme agreed upon between the network apparatus 200 and the security apparatus 300. The identification flagging unit 250 may perform a flagging operation when an identification flag mode is set in the network apparatus 200.

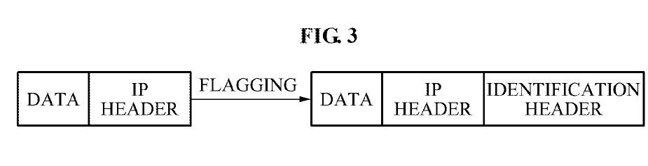

FIG. 3 is a diagram illustrating an example of as flagging operation to identify detected data as suspect data. In FIG. 3, the detected data includes data and an Internet Protocol (IP) header. To flag the detected data as suspect data, the identification flagging unit 250 may attach an identification header to a packet of the detected data. Alternatively, the identification flagging unit 250 may flag the detected data with an identifier, instead of attaching the identification header. The identifier may be used to identify the suspect data.

The security apparatus 300 may be notified of the detected suspect data apparatus by at least one of two schemes described above, so that the security apparatus 300 may easily identify data that is to be more precisely analyzed.

When suspect data is detected by the data monitoring, unit 240, and when the identification flag mode is set in the network apparatus 200, the first controller 260 may control the identification flagging unit 250 to flag the detected suspect data, and may control the first communication unit 210 to forward the flagged suspect data to the security apparatus 300.

Conversely, when the identification flag mode is not set in the network apparatus 200, the first controller 260 may control the first communication unit 210 to forward, to the security apparatus 300, the detected suspect data and flow information of the detected suspect data. Here, the flow information may include at least one of a source address, a destination address, and a port number that are associated with the suspect data. The source address may be an address for the external device 10, and the destination address may be an address for the service server 400.

As described above, the first communication unit 210 may forward, to the security apparatus 300, suspect data flagged as anomalous data or flow information of the suspect data. Additionally, the first communication unit 210 may receive an analysis result for the suspect data from the security apparatus 300, and may forward the received analysis result to the first controller 260.

The first controller 260 may perform at least one of the first operation and the second operation. Here, the first operation may be performed to control traffic based on the analysts result for the suspect data provided by the security apparatus 300. The second operation may be performed to control the traffic based on the rule set in advance, before the first operation is performed.

Hereinafter, the first operation will be further described.

The analysis result for the suspect data provided by the security apparatus 300 may include information regarding an attack pattern of the suspect data, and information regarding a protection operation to be performed by the network apparatus 200. The information regarding the protection operation in is include at least one of a rate limit for the traffic, a complete dropping of the traffic, and a dropping probability for the traffic.

When the attack pattern included in the analysis result is identical to an attack pattern of a DDoS attack, the first controller 260 may drop the traffic of the DDoS attack, based on the protection operation for the traffic that is included in the analysis result. Additionally, the first controller 260 may register the attack pattern included in the analysis result in the attack pattern registration unit 220, and may register the protection operation included in the analysis result in the protection operation registration unit 230.

Hereinafter, the second operation will be further described. When suspect data is detected, the first controller 260 may control traffic based on at least one of rules set in advance by the protection operation registration unit 230. In other words, the first controller 260 may protect against an attack by the suspect data based on the at least one of rules set in advance by the protection operation registration unit 230.

When the analysis result is received from the security apparatus 300 while the second operation is performed, the first controller 260 may protect against the attack by the suspect data, based on the protection operation that is included in the received analysis result.

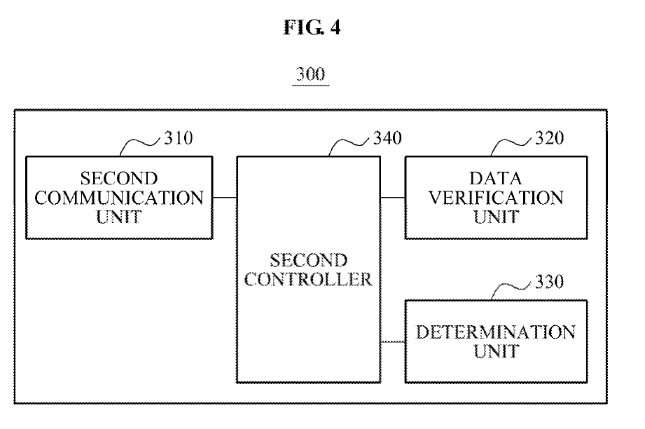

FIG. 4 is a block diagram illustrating the security apparatus 300 of FIG. 1 for collaboratively protecting against a DDoS attack.

The security apparatus 300 of FIG. 4 may receive the detected suspect data from the network apparatus 200, and may forward the analysis result for the suspect data to the network apparatus 200. As shown in FIG. 4, the security apparatus 300 may include a second communication unit 310, a data verification unit 320, a determination unit 330, and a second controller 340.

The second communication unit 310 may receive data from the network apparatus 200, and may transmit a precise analysis result for the data to the network apparatus 200. The network apparatus 200 may monitor traffic forwarded to the service server 400.

The data verification unit 320 may verify whether the received data is identified as suspect data suspected as being used in a DDoS attack, based on flow information of the received data, or flag information included in the received data. For example, when the identification header is attached to a packet of the received data as shown in FIG. 3, the data verification nit 320 may determine the received data as suspect data.

When the received data is identified as the suspect data, the determination unit 330 may precisely analyze the suspect data, may determine whether the suspect data is used in the DDoS attack, and may extract an attack pattern from the suspect data. Conventionally, a received data may be precisely anal zed by checking a signature stored in advance for each flow of the received data. However, the determination unit 330 may precisely analyze the suspect data by checking a signature of the suspect data only.

The second controller 340 may add information regarding a protection operation against the attack pattern of the suspect data to the precise analysis result. Accordingly, the precise analysis result may include information regarding the attack pattern of the suspect data, and information regarding the protection operation to be performed by the network apparatus 200. The second controller 340 may control the second communication unit 310 to transmit the precise analysis result to the network apparatus 200.

When the determination unit 330 determines that the received data is not identified as suspect data, the second controller 340 may control the network apparatus 200 to prevent flagging of the data as the suspect data, and may request the network apparatus 200 to forward the data, since traffic expected as anomalous traffic is determined as a normal service.

The security apparatus 300 may transmit the analysis result to the network apparatus 200 using a data channel or a management channel. When the data channel is used, the network apparatus 200 may recognize the received analysis result as an attack pattern. Accordingly, the security apparatus 300 may request the network apparatus 200 to set, in advance, the analysis result as permitted data.

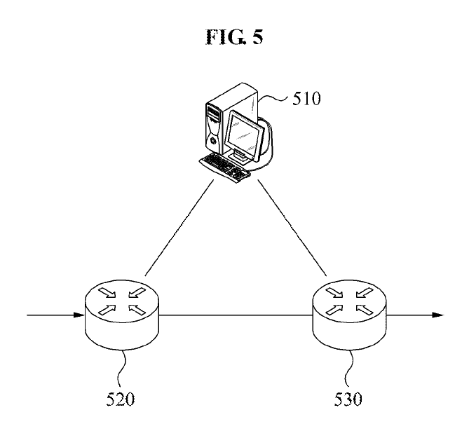

FIG. 5 is a diagram illustrating a part of a network system for collaboratively protecting against a DDoS attack according to another embodiment of the present invention.

Referring to FIG. 5, the network system may include a network control system 510, a first network apparatus 520, and a second network apparatus 530, in addition to the security apparatus 300 and the service server 400 of FIG. 1.

When the service server 400 is attacked by at least one of the external devices 10, 20, and 30, the first network apparatus 520 may transmit data to the second network apparatus 530. The second network apparatus 530 may detect suspect data suspected as being used in a DDoS attack by monitoring traffic of the data received from the first network apparatus 520. The second network apparatus 530 may flag the detected suspect data based on a scheme agreed upon with the security apparatus 300, and may forward the flagged suspect data to the security apparatus 300.

The security apparatus 300 may precisely analyze the suspect data, may determine an attack pattern, and may transmit, to the second network apparatus 530, a precise analysis result including information regarding a protection operation. Here, the security apparatus 300 may request the second network apparatus 530 so that the traffic of the DDoS attack may be dropped by a network ingress apparatus. The network ingress apparatus may be implemented, for example, as a router. The second network apparatus 530 may transmit, to the network control system 510, the information regarding the protection operation that is contained in the analysis result, and the network control system 510 may control the first network apparatus 520 to drop the DDoS attack based on the information regarding the protection operation.

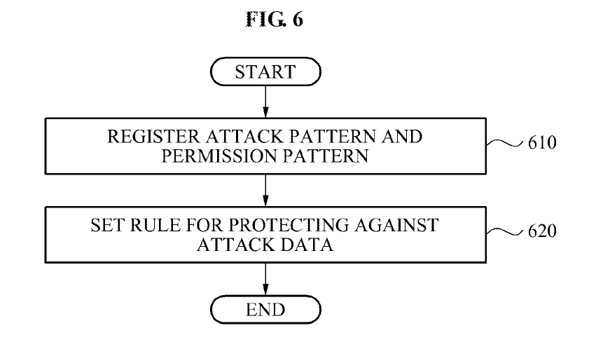

FIG. 6 is a flowchart illustrating a scheme of setting a rule for an attack pattern and a protection in a network apparatus according, to an embodiment of the present invention.

The scheme of FIG. 6 may be performed by the network apparatus 200 of FIG. 1, or by the second network apparatus 530 of FIG. 5.

In operation 610, the network apparatus may register an attack pattern and a permission pattern that are input by an operator. The attack pattern may be a pattern of data input from external devices, and the permission pattern may be used to identify data other than attack data among the input data.

In operation 620, the network apparatus may set, in advance, a rule that is used to protect against suspect data suspected as being used in an attack by external devices. The rule set in advance may include at least one of a rate limit for traffic, a complete dropping of traffic, and a dropping probability for traffic.

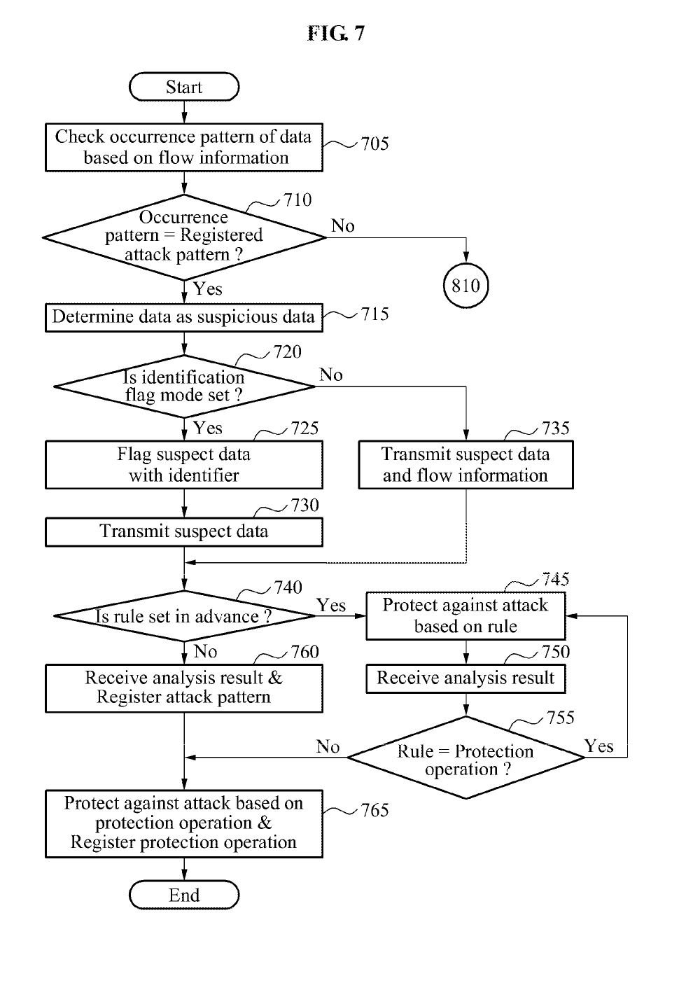

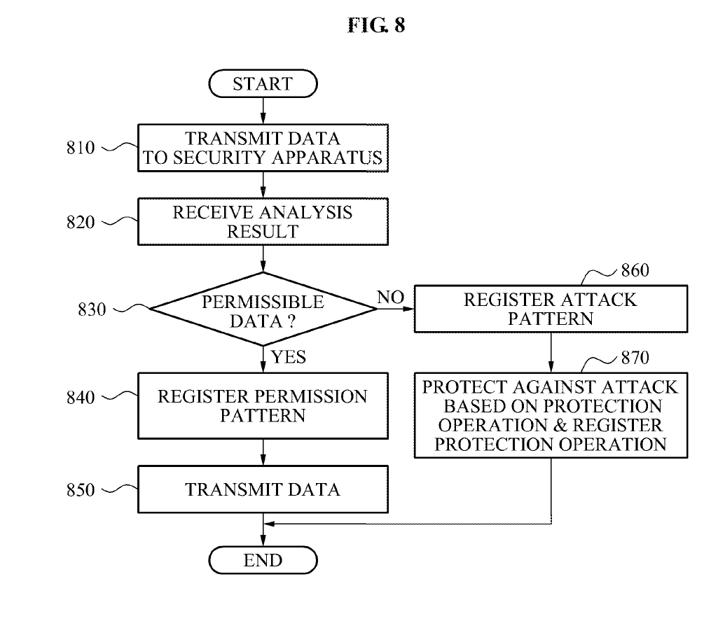

FIGS. 7 and 8 are flowcharts illustrating a method of collaboratively protecting against a DDoS attack in a network apparatus according to arm embodiment of the present invention.

The method of FIGS. 7 and 8 may be performed by the network apparatus 200 of FIG. 1, or by the second network apparatus 530 of FIG. 5.

In operation 705, the network apparatus may monitor traffic of data that is forwarded from external devices to a service server, and may check for an occurrence pattern of input data based on flow information of the input data.

In operation 710, the network apparatus may determine whether the occurrence pattern is identical to an attack pattern registered in an attack pattern registration unit.

When the occurrence pattern is identical to the registered attack pattern in operation 710, the network apparatus may determine the input data as suspect data suspected as being used in the DDoS attack in operation 715. The occurrence pattern of the input data may be determined based on at least one of an amount of data input per unit time, information on whether data having a same size repeatedly occurs, and, information on whether data for a specific function repeatedly occurs.

When an identification flag mode is set in the network apparatus in operation 720, the network apparatus may flag the suspect data with an identifier indicating that anomalous data is detected in operation 725. For example, the network apparatus may attach a header to the input data, or ma flag the detected data.

In operation 730, the network apparatus may transmit the suspect data flagged with the identifier to the security apparatus.

Conversely, when the identification flag mode is not set in the network apparatus in operation 720, the network apparatus may transmit, to the security apparatus, the suspect data and flow information of the suspect data in operation 735. Here, the flow information may include at least one of a source address, a destination address, and a port number.

When a rule is set in advance in the network apparatus in operation 740, the network apparatus may protect against an attack based on the ride in operation 745. In other words, the network apparatus may control traffic based on the rule set in advance.

When an analysis result is received from the security apparatus in operation 750 while operation 745 is performed, the network apparatus may determine whether the rule is the same as information regarding a protection operation in operation 755. Here, the information regarding the protection operation may be contained in the analysis result.

When the rule is the same as the information regarding the protection operation, the network apparatus may continue to perform operation 745.

Conversely, when the ride is different from the information regarding the protection operation, the network apparatus may perform operation 765.

In operation 760, the network apparatus may receive the analysis result from the security apparatus, and may register an attack pattern contained in the analysis result in the network apparatus.

In operation 765, the network apparatus may protect against an attack by traffic using the protection operation, and may register the protection operation in the network apparatus.

When the occurrence pattern is not registered in the attack pattern registration unit in operation 710, the network apparatus may perform operation 810.

Referring to FIG. 8, in operation 810, the network apparatus may transmit input data to the security apparatus.

In operation 820, the network apparatus may receive the analysis result for the input data from the security apparatus.

When the analysis result determines that the input data is permissible in operation 830, the network apparatus may register a permission pattern included in the analysis result in the network apparatus in operation 840.

In operation 850, the network apparatus may continue to transmit input data to the security apparatus.

Conversely, when the analysis result determines that the input data is not permissible in operation 830, the network apparatus may register an attack pattern included in the analysis result in the network apparatus in operation 860.

In operation 870, the network apparatus may protect against an attack by traffic using a permission pattern included in the analysis result, and ma register the protection operation in the network apparatus.

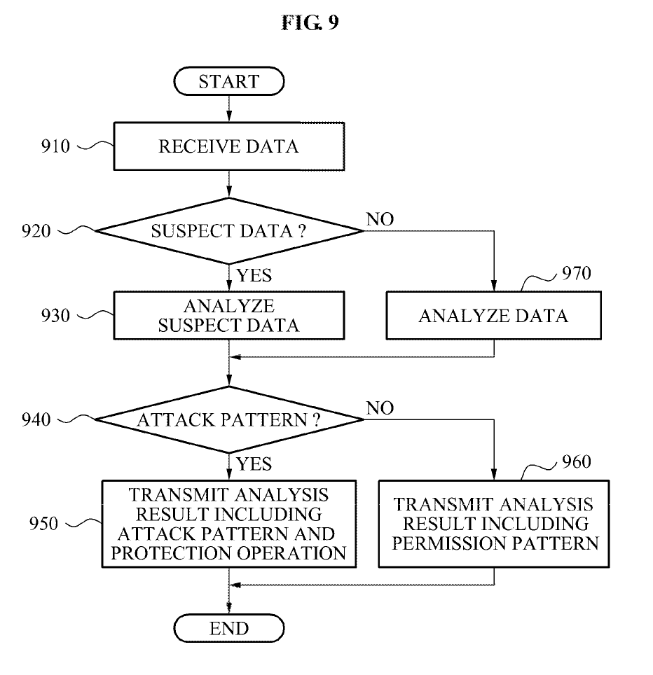

FIG. 9 is a flowchart illustrating a method of collaboratively protecting against a DDoS attack in a security apparatus according to an embodiment of the present invention.

The method of FIG. 9 may be performed by the security apparatus 300 described above with reference to FIGS. 1 and 5.

In operation 910, the security apparatus may receive data from to network apparatus that monitors traffic forwarded to a service server.

In operation 920, the security apparatus may verify whether the received data is identified as suspect data suspected as being used in a DDoS attack. Specifically, the security apparatus may use flow information of the data received in operation 910, or flag information included in the received, data, to verify whether the received data is identified as suspect data.

When the data is verified to be the suspect data, the security apparatus may precisely analyze the data, and may determine whether the data is used in the DDoS attack in operation 930. The precise analysis result for the data may include information regarding an attack pattern of the data, and information regarding a protection operation that is to be performed by the network apparatus.

When the suspect data is determined, to have an attack pattern in operation 940 by analyzing the data in operation 930, the security apparatus may transmit, to the network apparatus, an analysis result including the attack pattern and a protection operation in operation 950.

Conversely, when the suspect data is determined to have a permission pattern in operation 949 by analyzing the data in operation 930, the security apparatus may transmit, to the network apparatus, an analysis result including the permission pattern in operation 960.

When the received data is not identified as the suspect data in operation 920, the security apparatus may analyze the received data determine whether the data has an attack pattern in operation 970.

The security apparatus may perform operations 940 through 960 based on an analysis result obtained in operation 970.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of collaboratively protecting against a Distributed Denial of Service (DDoS) attack, the method being performed by a network apparatus, and comprising:
detecting data suspected as being used in the DDoS attack by monitoring traffic forwarded to a service server;
notifying a security apparatus that the detected data is suspected as being used in the DDoS attack; and
performing at least one of a first operation and a second operation, the first operation being receiving an analysis result for the detected data from the security apparatus and controlling the traffic based on the analysis result, and the second operation being controlling, prior to the first operation, the traffic based on a rule set in advance.

2. The method of claim 1, wherein the detecting comprises:
checking far an occurrence pattern of input data based on flow information of the input data;
determining whether the occurrence pattern of the input data is identical to an attack pattern registered in the network apparatus; and
determining the input data suspected as being used in the DDoS attack, when the occurrence pattern of the input data is identical to the attack pattern registered in the network apparatus.

3. The method of claim 2, wherein the occurrence pattern of the input data is determined based on at least one of an amount of data input per unit time, information on whether data having a same size repeatedly occurs, and information on whether data for a specific function repeatedly occurs.

4. The method of claim 1, wherein the notifying comprises:
flagging the detected data as anomalous data, based on a scheme agreed upon between the network apparatus and the security apparatus; and
forwarding the flagged data to the security apparatus.

5. The method of claim 1, wherein the notifying comprises:
providing the security apparatus with flow information of the detected data, the flow information comprising at least one of a source address, a destination address, and a port number; and
forwarding the detected data to the security apparatus.

6. The method of claim 1, wherein the analysis result comprises information regarding an attack pattern of the detected data, and information regarding a protection operation to be performed by the network apparatus.

7. The method of claim 6, wherein the information regarding the protection operation comprises at least one of a rate limit for the traffic, a complete dropping of the traffic, and a dropping probability for the traffic.

8. The method of claim 1, wherein the first operation comprises:
registering an attack pattern contained, in the analysis result, when the analysis result indicates an attack pattern of the DDoS attack; and
dropping the traffic of the DDoS attack based on the protection operation for the traffic, the protection operation being contained in the analysis result.

9. The method of claim 8, wherein the dropping comprises:
registering the protection operation for the traffic; and
transmitting information regarding the protection operation to a network control system so that the traffic of the DDoS attack is dropped by a network ingress apparatus.

10. The method of claim 1, wherein the rule comprises at least one of a rate limit for the traffic, a complete dropping of the traffic, and a dropping probability for the traffic.

11. A method of collaboratively protecting against a DDoS attack, the method being performed by a security apparatus, and comprising:
receiving data from a network apparatus, the network apparatus monitoring traffic forwarded to a service server;
verifying whether the data is suspected as being used in the DDoS attack, based on flow information of the received data or flag information included in the received data, the flow information being provided by the network apparatus;
analyzing the data and determining whether the data is used in the DDoS attack, when the data is suspected as being used in the DDoS attack; and
transmitting a analysis result for the data to the network apparatus.

12. The method of claim 11, wherein the analysis result comprises information regarding an attack pattern of the data, and information regarding a protection operation to be performed by the network apparatus.

13. A network apparatus for collaboratively protecting against a DDoS attack, the network apparatus comprising:
a data monitoring unit to detect data suspected as being used in the DDoS attack by monitoring traffic forwarded to a service server;
a communication unit to notify a security apparatus that the detected data is suspected as being used in the DDoS attack; and
a controller to perform at least one of a first operation and a second operation, the first operation being receiving an analysis result for the detected data from the security apparatus and controlling the traffic based on the analysis result, and the second operation being controlling, prior to the first operation, the traffic based on a rule set in advance.

14. The network apparatus of claim 13, wherein the data monitoring unit comprises:
a pattern determiner to check for an occurrence pattern of input data based on flow information of the input data, and to determine whether the occurrence pattern of the input data is identical to an attack pattern registered in the network apparatus; and
a suspect data determiner to determine the input data suspected as being used in the DDoS attack, when the occurrence pattern of the input data is identical to the attack pattern registered in the network apparatus.

15. The network apparatus of claim 13, further comprising:
an identification flagging unit to flag the detected data as anomalous data based on a scheme agreed upon between the network apparatus and the security apparatus,
wherein the communication unit forwards the flogged data to the security apparatus.

16. The network apparatus of claim 13, wherein the communication unit forwards, to the security apparatus, the detected data and flow information of the detected data, the flow information comprising at least one of a source address, a destination address, and a port number.

17. The network apparatus of claim 13, wherein, when the analysis result indicates an attack pattern of DDoS attack, the controller performs the first operatic by registering an attack pattern contained in the analysis result, and by dropping the traffic of the DDoS attack based on the protection operation for the traffic, the protection operation being contained in the analysis result.

18. The network apparatus of claim 17, further comprising:
a protection operation registration unit to register the protection operation for the traffic.

19. The network apparatus of claim 17, wherein the controller transmit information regarding the protection operation to a network control system so that the traffic of the DDoS attack is dropped by a network ingress apparatus.
